(19) United States
(12) Patent Application Publication
(10) Pub. No.: US 2017/0289664 A1
(43) Pub. Date: Oct. 5, 2017

(54) Interchangeable Covering System for Microphones

(71) Applicant: Daniel St Clair, (US)

(72) Inventor: Daniel St Clair, Wellesley, MA (US)

(73) Assignee: Daniel St Clair, Wellesley, MA (US)

(21) Appl. No.: 15/475,980

(22) Filed: Mar. 31, 2017

Related U.S. Application Data
(60) Provisional application No. 62/317,503, filed on Apr. 2, 2016.

(51) Int. Cl. H04R 1/08; H04R 1/32

(52) U.S. Cl. CPC H04R 1/086; H04R 1/326; H04R 2499/11

(57) ABSTRACT

The present invention is a microphone that incorporates a system of removable covers that can change the acoustic characteristics of the microphone, provide enhanced environmental protection for the microphone, and add additional features through electronic sensors and other means. The invention consists of one or more microphone capsules mounted inside of an enclosure, which has a physical fastening system such as flanges, screw threads, or other means. This fastening system mates with a variety of microphone covers that can change the characteristics of the microphone. These covers may act as wind screens, acoustic baffles, phase cancellation guides, water and dust seals, impact bumpers, and may also add additional functionality through the incorporation of electronic sensors

### BACKGROUND OF THE INVENTION

The present invention is in the technical field of audio recording. More particularly, the present invention is in the technical field of microphone design. More particularly, the present invention is in the field of microphone coverings.

Traditionally, microphones are designed using a cylindrical or semi-cylindrical body that houses a microphone capsule behind an acoustically transparent grille or mesh. To control the unwanted effects of wind, whether human generated or environmentally generated, it is common practice to affix various windscreens or other acoustic filters around the microphone. These include windscreens that slip over the microphone, and pop filters that are positioned between the microphone and the lips of a vocalist or speaker. These solutions are physically cumbersome, bulky, and expensive. In addition, they do not lend themselves well to body worn microphones or to compact microphones in general. The present invention solves many of these issues.

### SUMMARY OF THE INVENTION

The present invention is an audio recording system that incorporates an enclosure for a microphone capsule and a plurality of removable covers that can be attached and detached from this enclosure using a fastening system. These covers can change the acoustic characteristics of the microphone, provide enhanced environmental protection for the microphone, and add additional features through electronic sensors and other means.

The system for audio recording has several key components: the enclosure for the microphone capsule, a plurality of microphone covers that attach to this enclosure, and a fastening system to join the enclosure and the covers. The enclosure may contain a one or more microphone capsules of condenser, electret, MEMS, or other types, as well as electronic circuitry, battery packs, and connectors. The enclosure may include air ports, acoustic grilles, foam, or other materials. The enclosure includes a fastening system that may use flanges, screw threads, snap fits, or other fastening means, that mate with corresponding fasteners on a variety of covers that surround the microphone capsule. Variations of these covers may vary in their acoustic effect, size, materials, and other qualities. Variations of these covers may act as wind-screens, incorporating acoustic baffles through various materials. Variations of these covers may act to change the directivity of the microphone, creating phase cancellation or other acoustic effects. Variations of these covers may include waterproof gaskets, membranes, rubberized bumpers, or other materials. Variations of these covers may also include electronic circuits including sensors for physical proximity, capacitance, vibration, wind speed, light, moisture, or other sensors.

### BRIEF DESCRIPTION OF THE DRAWINGS

FIG. 1 is a perspective view of the microphone capsule housing with attachment flanges

FIG. 2 is a top view of FIG. 1

FIG. 3 is a side view of FIG. 1

FIG. 4 a perspective view of the microphone capsule housing with a microphone cover attached

FIG. 5 is a perspective view of a variation of microphone cover

FIG. 6 is a top view of FIG. 5

FIG. 7 is a bottom view of FIG. 5

FIG. 8 is an exploded view of a variation of the microphone cover components

FIG. 9 is a perspective view of a variation of microphone cover embodying a phase cancellation directional cover

FIG. 10 is a side view of a FIG. 9

FIG. 11 is a perspective view of a variation of microphone cover shown in Fig attached to a microphone enclosure as shown in FIG. 1

FIG. 12 is a perspective view of a variation of microphone cover with apertures on an alternate axis

FIG. 13 is a top view of FIG. 12

FIG. 14 is a perspective view of a variation of microphone cover providing waterproofing

FIG. 15 is a cutaway view FIG. 14

FIG. 16 is a perspective view of a variation of microphone cover with integrated sensor

FIG. 17 is a top view FIG. 16

### DETAILED DESCRIPTION OF THE INVENTION

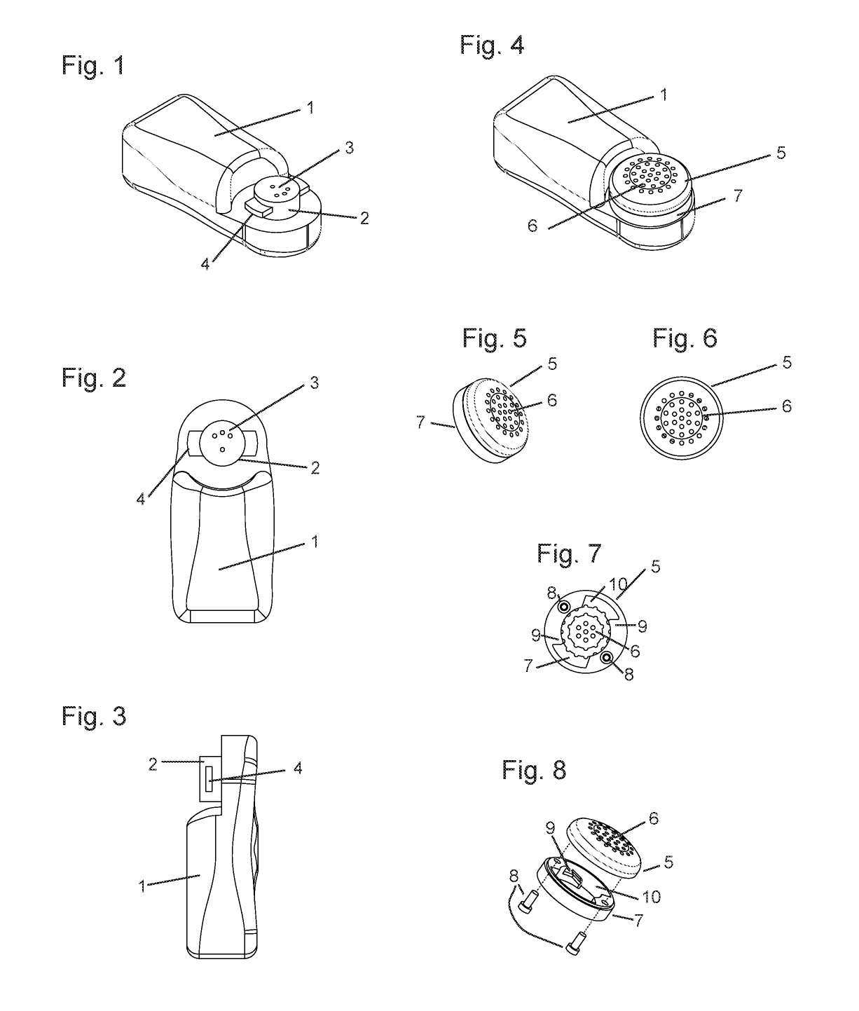

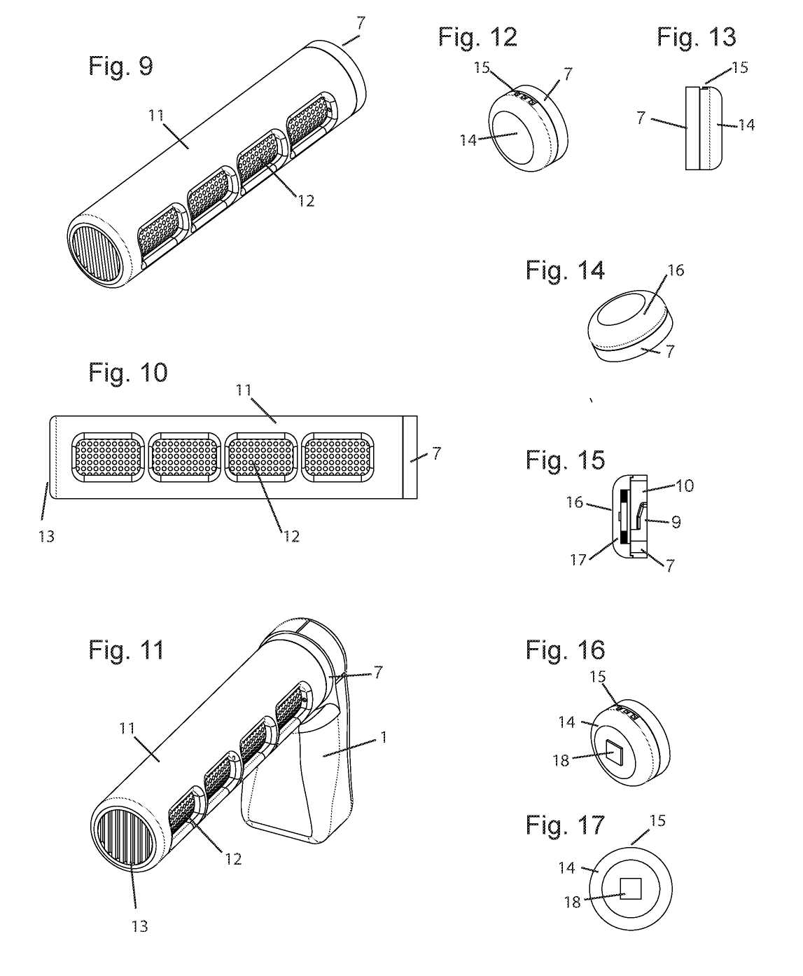

Referring now to the invention in more detail, in FIG. 1 there is shown an enclosure for a microphone capsule consisting of a body 1, microphone capsule 2, microphone capsule housing with air vents 3, and attachment system 4 consisting of flanges, threads, or other attachment means. The body 1 may contain electronic circuits, batteries, connectors, and other components for the amplification, storage, and processing of sound. For example, one embodiment would include a pre-amp for the microphone capsule 2, analog to digital converter, microcontroller, flash storage such as eMMC, usb connector, battery, and other supporting electronics such as wireless connectivity.

The attachment system is designed to mate with a variety of covers, a variation of which is shown in FIG. 5. The covers have an acoustic structure such as a baffle 6, an impact bumper 5, and a mating mechanism 7 that attaches to the attachment system on the microphone enclosure 4. FIG. 4 shows a variation of microphone cover attached to the microphone housing in FIG. 1. The mating mechanism 7 may be a separate part that fastens to variations of caps using screws, plastic welding, or other means. The variation of the mating mechanism 7 shown her includes a tapered locking mechanism 9 and a void 10 that allows the microphone cover to be placed over the microphone capsule housing 3 and rotated clockwise so that the flanges on the microphone body 4 form a friction lock with the corresponding locking mechanism 9 on the microphone cover. FIG. 6, FIG. 7, and FIG. 8 show alternate views of the variation of microphone cover shown in FIG. 5, including the fasteners 8 used to attach the mating mechanism 7 to the microphone cover.

FIG. 9 shows a variation of microphone cover that uses a mating mechanism 7 and a body 11 having phase cancellation apertures covered in acoustic grills 12 and a front acoustic grill 13. FIG. 10 shows a side view of FIG. 9. FIG. 11 shows the microphone cover variation found in FIG. 9 attached to the body containing the microphone capsule 1, via the mating mechanism 7. FIG. 12 and FIG. 13 shows a variation of microphone cover that uses a mating mechanism 7, rubber top bumper 14, and side apertures for allowing air to pass to the microphone. FIGS. 14 and 15 show a variation of microphone cover that is sealed using a gasket 17 and includes an outer shell 16 and mating mechanism 7 including a tapered locking mechanism 9 and a void 10.

Covers may also include electronic sensors. A variant of cover including electronic sensors is shown in FIG. 16 and FIG. 17, comprising an outer cover 14, apertures for the passage of air to the microphone capsule 15, and an electronic circuit 18 comprising a plurality of sensors. These sensors may relay information back to circuits in the microphone body through physical electronic contacts or wirelessly for storage or real-time signal processing of the audio recorded. The types of sensors used may include but are not limited to proximity, light, heart rate, wind speed, moisture, and capacitance. As an example of way in which that these sensors are employed, one embodiment may use data from a proximity and light sensor to sense potential contact and handling noise, triggering corresponding algorithms running on circuitry in the microphone body to filter out this noise.

While the embodiment shown here uses flanges and a twist-to-lock mechanism on the microphone cover, a wide variety of locking mechanism between the body housing the microphone capsule and the removable covers are possible. For example, screw threads may be used. Snap-fit or press fit mechanisms may be used. Belts, straps, or other mechanisms may also be used.

While the embodiment show here includes several examples of microphone covers, an extremely wide variety of microphone covers are possible. For example, the microphone opening 3 may be made up of a wide variety of acoustic materials, including foam, acoustic meshes made from plastic, metal, woven meshes, and many other materials. The microphone covers shown here may contain many combinations of reticulated and non-reticulated foams, baffles made from a variety of materials, and a variety of other structures intended to modify the passage of air vibrations to the microphone capsules. The apertures 12 on the directional phase cancellation microphone may be of various shapes, including but not limited to slits, ovals, circles, and other shapes.

An entirely new variant of the system is possible, whereby the individual microphone covers contain one or more microphone capsules, and the microphone body contains supporting circuitry.

The advantages of the present invention include, without limitation, the ability to endow a single microphone with a variety of different acoustic characteristics, the ability to add additional features to an existing microphone, increased resistance to environmental factors such as wind and water, and increased functionality of the microphone.

In broad embodiment, the present invention is a microphone with a system of removable covers that can change the acoustic characteristics of the microphone, offer additional environmental protection to the microphone, or add additional functionality to the microphone.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1) a microphone for transducing airborne vibrations to electrical signals comprising: one or more transducer elements; a housing surrounding said transducer elements with an opening to permit airborne vibrations to enter ; one or more covers that attach to said housing to change the acoustical or mechanical properties of the microphone; a mechanical locking mechanism to secure said covers to said housing.

2) The invention of claim 1 further comprising covers that feature an acoustic mesh for the mechanical filtration of airborne vibration.

3) The invention of claim 1 further comprising covers that provide a seal for the prevention of ingress into said housing.

4) The invention of claim 1 further comprising covers that use fur as an acoustic baffle.

5) The invention of claim 1 further comprising covers that change the acoustic directivity of said microphone, using arrangements such as acoustic phase cancellation

6) The invention of claim 1 further comprising covers that integrate additional electronic sensors.

7) The invention of claim 1 further comprising covers that lock into place using flanges and a twist-to-lock mechanism.

8) The invention of claim 1 further comprising said microphone assembly integrated with a video camera.
